(19) United States
(12) Patent Application Publication
(10) Pub. No.: US 2016/0102246 A1
(43) Pub. Date: Apr. 14, 2016

(54) Stabilization of High Molecular Weight Polysaccharide Solutions at High Temperatures

(71) Applicant: FTS International Services, LLC, Fort Worth, TX (US)

(72) Inventors: Gabriel Monreal, Fort Worth, TX (US); Reinaldo Navarrete, Fort Worth, TX (US)

(73) Assignee: FTS INTERNATIONAL SERVICES, LLC, Fort Worth, TX (US)

(21) Appl. No.: 14/511,071

(22) Filed: Oct. 9, 2014

(51) Int. Cl. C09K 8/90; E21B 43/26

(52) U.S. Cl. CPC C09K 8/90; E21B 43/26

(57) ABSTRACT

A fluid mixture containing a high molecular weight polysaccharide composition with improved viscosity stability at high downhole temperatures and pressures encountered in common oil field applications, including hydraulic fracturing stimulation, drilling, cementing, and coil-tubing. The composition includes a salicylic acid solution, which, being a free-radical scavenger, prevents free-radical reactions within the high molecular weight polysaccharide that would otherwise adversely affect viscosity. The composition may also include an ascorbic acid solution, which reduces at least a portion of the oxidized salicylic acid to restore its function as a free-radical scavenger to prevent additional free-radical reactions with the high molecular weight polysaccharide. An alcohol solvent may also be utilized to increase the solution loading of salicylic acid.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to chemical additives used in the stabilization of high molecular weight polysaccharide solutions.

2. Description of Related Art Including Information Disclosed under 37 CFR 1.97 and 1.98

Hydraulic fracturing of subterranean formations is a widely practiced technique for enhanced oil and gas well recovery. During the hydraulic fracturing process, the fracturing fluid (for example, fluids comprising high molecular weight polysaccharide solutions such as cross-linked guar) is injected into a wellbore at a pressure and flow rate high enough to cause the formation of fractures within the subterranean formation. The fracturing fluid viscosity should be sufficient to transport proppants and other additives into the fractures that are formed. However, problems arise with insufficient or premature loss of fracturing fluid viscosity, which can occur due to the elevated downhole temperatures and mechanical degradation. This loss of viscosity can lead to poor proppant placement, insufficient fracture geometry, and, ultimately, lost or minimized production of the hydrocarbon resource from the formation's reservoir.

It is not uncommon for downhole temperatures in certain subterranean formations to reach temperatures in excess of 280° F. Unfortunately, fracturing fluids used at this high temperature are subject to premature loss of fluid stability (i.e., sustained viscosity), which may be attributed to oxidation of the viscosifying polymer by entrained oxygen or other reactive species generated by reactive oxygen that is present in the water. The addition of certain additives that stabilize the hydraulic fracturing gels is a common practice when sustained performance of the fracturing fluid is desired. Common gel stabilizers include sodium thiosulfate (Na₂S₂O₃), sodium sulfite (Na₂SO₃), and sodium erythorbate (C₆H₇NaO₆); they act as reducing agents that are believed to sacrificially combine with entrained oxygen and other reactive species (free radicals) that would otherwise decrease fluid stability. However, once these common gel stabilizers are oxidized (spent), they no longer participate in the stabilization of the fracturing fluid and the fracturing fluid viscosity usually decreases.

In addition, higher temperatures may necessitate the use of excessive amounts of common gel stabilizers in order to achieve desired viscosity stability over time. In these cases, these common gel stabilizers add to the overall expense for such an operation. What is needed is an environmentally friendly alternative that stabilizes polymers at high temperatures, while using a substantially lower amount of additive compared to commonly used stabilizers. The present invention satisfies these needs and others, as will become readily apparent from a detailed reading and understanding of the specification.

### BRIEF SUMMARY OF THE INVENTION

Described herein is a method for stabilizing the viscosity of aqueous fluids containing high molecular weight polysaccharide solutions used in subterranean formations at high temperatures and pressures, the method steps in a first embodiment comprising: admixing a salicylic acid solution into a high molecular weight polysaccharide solution to form a fluid mixture for introduction into a wellbore. Supplementary elements forming additional embodiments include method steps involving: admixing an ascorbic acid solution into the fluid mixture; injecting the fluid mixture into a subterranean formation at a sufficiently high pressure to create fractures; and formulating the salicylic acid solution by dissolving salicylic acid in an alcohol solvent. Further, additional solution embodiments utilize the maximum percentage by weight of salicylic acid that will remain in solution and others up to approximately 34.8% by weight of salicylic acid. Still other embodiments include method steps involving formulating the salicylic acid solution by dissolving salicylic acid in an alcohol solvent, and introducing the dissolved salicylic acid and alcohol solvent solution into water. Additional solution embodiments utilize the maximum percentage by weight of salicylic acid that will remain in solution; up to approximately 30.2% by weight salicylic acid; the maximum percentage by weight of ascorbic acid that will remain in solution; and up to approximately 25% ascorbic acid. Another embodiment includes the admixing at least one additive from the group consisting of biocides, scale inhibitors, clay controllers, surfactants, friction reducers, breakers, and crosslinkers into the fluid mixture.

Also described herein is a composition for stabilizing the viscosity of aqueous fluids containing high molecular weight polysaccharide solutions used in subterranean formations at high temperatures and pressures, the composition comprising: a high molecular weight polysaccharide solution; and a salicylic acid solution admixed with the high molecular weight polysaccharide solution to form a fluid mixture for introduction into a wellbore. Supplementary elements forming additional embodiments include an ascorbic acid solution admixed with the high molecular weight polysaccharide and salicylic acid solutions; wherein the salicylic acid solution is prepared by dissolving salicylic acid in an alcohol solvent; and wherein the salicylic acid solution preparation comprises the maximum percentage by weight of salicylic acid that will remain in solution. The composition in yet another embodiment includes up to approximately 34.8% by weight of salicylic acid. In another embodiment a composition is formed wherein the salicylic acid solution is prepared by dissolving salicylic acid in an alcohol solvent, and introducing the dissolved salicylic acid and alcohol solvent solution into water. Another embodiment includes the maximum percentage by weight of salicylic acid that will remain in solution; up to approximately 30.2% by weight salicylic acid; the maximum percentage by weight of ascorbic acid that will remain in solution; and up to approximately 25% by weight of ascorbic acid.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 is a block diagram presenting the arrangement of the components comprising a typical oil or gas well stimulation configuration as it connects to the wellbore;

FIG. 2 is a graph comparing the rheological performance of a crosslinked gel at 240° F. with various combinations of the component solutions disclosed in the embodiments described herein;

FIG. 3 is a graph comparing the rheological performance of a crosslinked gel at 260° F. with various combinations of the component solutions disclosed in the embodiments described herein;

FIG. 4 is a graph comparing the rheological performance of a crosslinked gel at 280° F. with various combinations of the component solutions disclosed in the embodiments described herein; and

FIG. 5 is a graph comparing the rheological performance of a linear gel at 260° F. with and without the combined component solutions disclosed in the embodiments described herein.

The above figures are provided for the purpose of illustration and description only, and are not intended to define the limits of the disclosed invention. Use of the same reference number in multiple figures is intended to designate the same or similar parts. Furthermore, if and when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

The present invention involves the use of high molecular weight polysaccharide solutions (including linear gels, crosslinked gels, and the like) to form fluid mixtures for use in common oil field applications, including, without limitation, hydraulic fracturing stimulation, drilling, cementing, and coil-tubing.

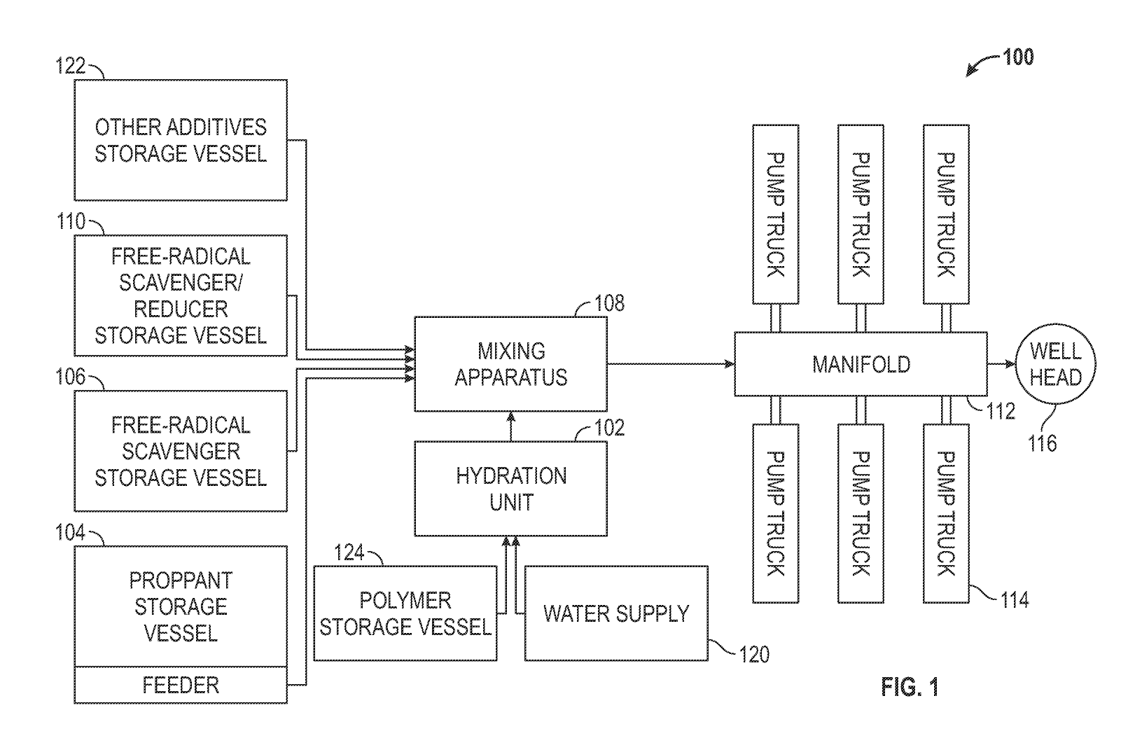

In short, a well stimulation operation requires the injection of a hydraulic fracturing fluid into a wellbore at considerable pressure and flow rate to force the formation of fissures within a subterranean formation in order to “unlock” the hydrocarbons that exist therein, thereby increasing the hydrocarbon production of the wellbore. A variety of heavy-duty equipment is required to perform this operation, as represented in FIG. 1.

FIG. 1 is a block diagram depicting the arrangement of the components comprising a typical oil or gas well stimulation configuration (100) as it connects to a wellbore. In aqueous-based fracturing fluids, the quantities of water used to make up the fracturing liquid can be exceedingly large. Consequently, large or even multiple vessels are utilized to store the base water (120). In preparation for injection in the wellbore, common thickening agents (124) are mixed with the base water (120) within the hydration unit (102) and, if desired, with proppant (104) and other additives, such as, biocides, scale inhibitors, clay controllers, surfactants, friction reducers, breakers, and crosslinkers, using a blender or other mixing apparatus (108). This fluid is then supplied to a series of high-pressure positive displacement pumps (114) where it is forced through a manifold (112) and injected downhole through the wellhead (116).

The novel free-radical scavenging substances described in the subsequent embodiments (salicylic acid and L-ascorbic acid) are, likewise, admixed at the well site with the polysaccharide solution prior to injection. Each substance, in solution, can be stored in a separate storage vessel (106 and 110), and is admixed, sequentially in any order or simultaneously, with the polysaccharide solution and, if desired, other additives to form the fracturing fluid solution using a blender or other mixing apparatus as appropriate (108). Setup and use of such hydraulic fracturing systems is well understood.

This invention uses two novel additives—salicylic acid (a natural precursor to acetyl salicylic acid or aspirin) and L-ascorbic acid (a form of Vitamin C)—that promote stabilization of high molecular weight polysaccharide solutions up to temperatures of 280° F. Although in some embodiments a single one of these additives may be used as a gel stabilizer, these new additives have been shown to work synergistically when combined. Each additive is a natural product that is environmentally benign and readily available. At high pH (for example, as in a borate-crosslinked guar fracturing fluid), these compounds exist in their conjugate base form (salicylate and ascorbate).

Salicylic acid (C₇H₆O₃) contains a phenolic functional group, which is known in organic chemistry to be a free-radical inhibitor. A free-radical inhibitor is a compound that can prevent free-radical reactions (such as the attack of radical oxygen on a guar polymer) from occurring. The usual action of free radical inhibitors is to undergo a reaction themselves with reactive radicals to form nonreactive or relatively stable radicals. Phenols, compounds in which a hydroxyl group is covalently bonded to an aromatic carbon ring, are effective free radical inhibitors because their radical products are resonance stabilized and, hence, relatively nonreactive.

Although the free-radical products of salicylic acid are relatively non-reactive, it is possible and beneficial (in particular, to gel stability of fracturing fluids) to regenerate the salicylate radical product for its continued efficacy as an active free-radical inhibitor. This can be accomplished by the addition of L-ascorbic acid (C₆H₈O₆), which is believed to serve as a reducing agent. In biological systems, L-ascorbic acid is known to regenerate the antioxidant Vitamin E, a phenol containing-molecule, thereby protecting cell membranes and reducing damage induced by radicals and radiation.

Empirical evidence obtained during testing indicates that the L-ascorbic acid (ascorbate) regenerates the salicylic acid from its radical derivatives, making the salicylic acid (salicylate) available for re-use as a free-radical inhibitor for the fracturing fluid. The ascorbate radical that is generated is known to have a very low reactivity as an oxidizing radical. In fact, high temperature (>240° F.) rheological testing has shown that this low reactivity renders the ascorbate radical fairly innocuous to a fluid system comprised of high molecular weight polysaccharide gel. Based upon testing, it is believed that the following conceptual summary occurs during this process (a dot represents a free-radical species):

G→G. (Gel is damaged by reactive oxygen or other free radicals) (1)

G.+SA→G+SA. (Damaged gel is restored by salicylate; relatively stable salicylate radical inhibitor is generated) (2)

SA.+AA→SA+AA. (Salicylate radical is regenerated by ascorbate, making salicylate free-radical inhibitor available to prevent damage to viscosifying polymer gel again, as in equation (2)) (3)

G.+SA→G+SA. (4)

Salicylic acid and L-ascorbic acid are solids at room temperature that may be formulated into water-based solutions for ease of pumping and accurate metering in field applications. Liquid additives are sometimes preferable for hydraulic fracturing operations because they can often be more easily pumped and are compatible with the storage totes, chem-add units, blenders, and other equipment typically used in hydraulic fracturing operations.

Unlike Vitamin E, which is lipid-soluble, salicylic acid is a sparingly water-soluble phenol, which is advantageous because it can be solvated in a water-based fracturing fluid formulation. It is possible to prepare a salicylic acid solution for use herein by merely dissolving the salicylic acid directly into water. The condition of the water into which the salicylic acid is dissolved will determine the percent by weight of salicylic acid that will stay in solution and, therefore, be capable of use in formulating the stabilized gel described herein. At room temperature, it is typically possible to dissolve approximately 2.0 grams of salicylic acid per liter of water. To increase the concentration of salicylic acid in solution, it is possible to first dissolve the salicylic acid in an alcohol solvent, which has a high affinity for water. Common alcohol solvents include isopropyl alcohol, methyl alcohol, ethanol, polypropylene glycol, and the like. One embodiment of the salicylic acid solution includes up to approximately 34.8% by weight salicylic acid; the remainder is alcohol solvent (no additional water is added). However, water may also be added to the solution. When water is added, another embodiment of the salicylic acid solution includes up to approximately 30.2% by weight salicylic acid, up to approximately 43.2% by weight isopropyl alcohol, and the remainder water.

L-ascorbic acid, on the other hand, is quite water-soluble and, therefore, is capable of high loadings. The L-ascorbic acid may be dissolved directly into water to form the ascorbic acid solution to operate as the salicylic acid reducer and/or a free-radical scavenger. One embodiment of the ascorbic acid solution includes up to approximately 25% ascorbic acid with the remainder water (all weight percent).

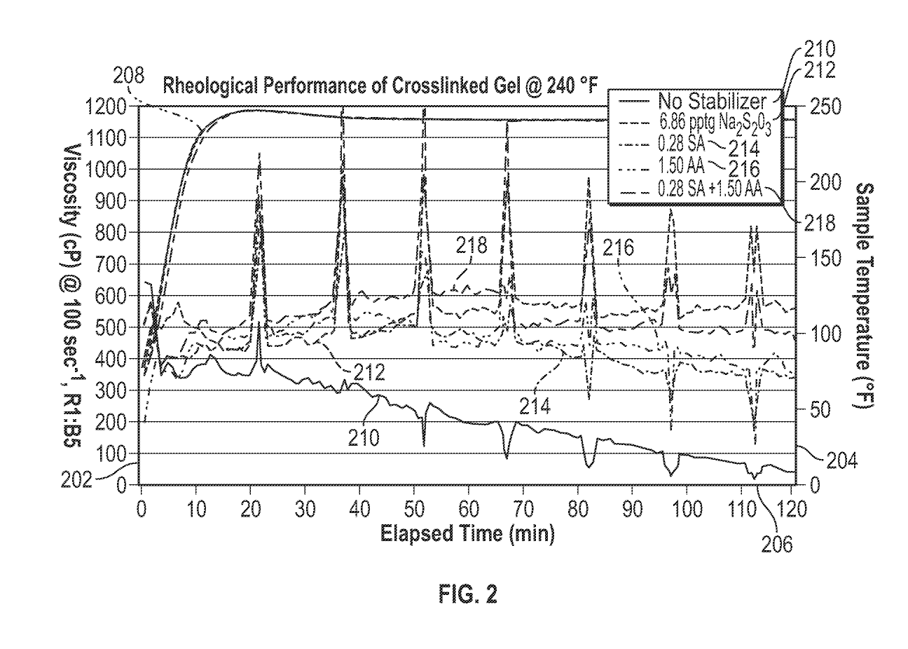

Salicylic acid and L-ascorbic acid are relatively inexpensive, benign, naturally derived alternatives that stabilize fracturing fluid up to a temperature of at least 280° F. FIG. 2 shows how these additives work singularly and synergistically to provide gel stabilization, as compared to a fluid with no stabilization, thereby enabling the fluid to maintain viscosity for a longer period of time at temperature, all the while using a lesser amount of the active stabilization materials.

FIG. 2 is a graph comparing the rheological performance of a borate crosslinked gel at 240° F. with various combinations of the component solutions disclosed in the embodiments described herein. From this graph, it can be seen that the fluids containing some type of stabilizer generally maintains fluid stability (i.e., viscosity) for a longer period of time. The graph compares viscosity (202) of a high molecular weight polysaccharide solution, which in this instance is an approximate 30 pptg concentration of borate-crosslinked guar gel, for a given sample temperature (204) over time (206). The corresponding temperature of each fluid sample is provided (208), thereby demonstrating the temperature consistency across each sample. As used herein, the label “pptg” means “pounds per thousand gallons” and indicates the pounds (lbs) of the stated component used per 1000 gallons of fluid. The additive concentrations are commonly expressed as “pptg” or “gpt”—gallons of additive per 1000 gallons of fluid—at the fracturing site.

A baseline of the gel without stabilizer (210) is provided. It can be seen that at a sample gel temperature of 240° F., the viscosity decreased steadily during the measurement period. Next, approximately 6.86 pptg of sodium thiosulfate was added to the gel. The sodium thiosulfate (a traditional stabilizing agent) maintained viscosity as expected (212), exhibiting improvement in viscosity over time with respect to the baseline (210).

Because the free-radical products of salicylic acid are relatively non-reactive, a first embodiment of the invention is a formulation using only the salicylic acid solution as a stabilizer. As shown on the graph, the formulation containing an approximate 0.28 pptg concentration of salicylic acid in the gel performed exceptionally (214) with respect to the untreated gel (210), and with respect to the traditional stabilizer (212)—albeit to a slightly lesser effect as time elapsed.

Another embodiment is a formulation using only the ascorbic acid solution as a stabilizer for its free-radical scavenging effects. The graph of gel formulation containing an approximately 1.5 pptg concentration of ascorbic acid solution indicates a stabilizing effect (216) that closely follows that of the salicylic acid formulation (214).

Yet another embodiment is a formulation using both the salicylic acid (at approximately 0.28 pptg) and ascorbic acid (at approximately 1.5 pptg) solutions combined, presenting evidence of the synergistic effect (218) of the combination. At temperature, this combination of salicylic acid and ascorbic acid demonstrates stabilizing behavior (218) greater than that of the traditional sodium thiosulfate (212) at an elapsed time range up to approximately 70 minutes and close to that of the traditional sodium thiosulfate (212) at an elapsed time greater than approximately 70 minutes. This notable performance is achieved although a far lesser amount (approximately 1.78 pptg) of the combined solutions is used compared to the amount of sodium thiosulfate alone (approximately 6.86 pptg).

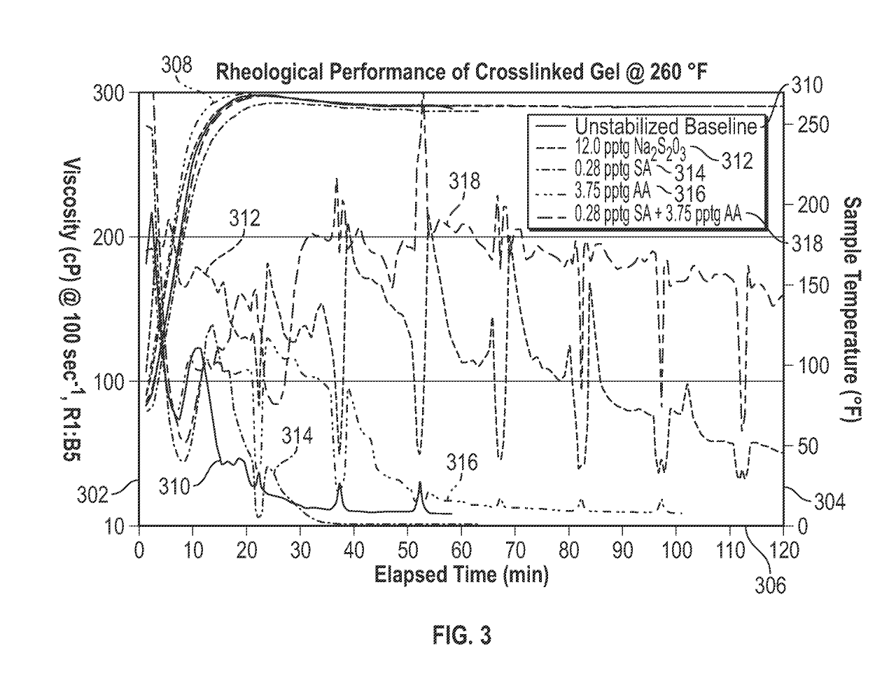

FIG. 3 is a graph comparing the rheological performance of a 20 pptg borate-crosslinked gel at 260° F. with various combinations of the component solutions disclosed in the embodiments described herein. This graph compares viscosity (302) of this high molecular weight polysaccharide solution (20 pptg borate-crosslinked guar gel) for the given increased sample temperature (304) over time (306). The corresponding temperature of each fluid sample is provided (308), thereby demonstrating the temperature consistency across each sample. A baseline of the gel without stabilizer (310) is provided. In this test, the formulation using traditional sodium thiosulfate at a concentration of 12.0 pptg (312) demonstrated an expected improvement in viscosity of the gel over the entire time period. Use of a formulation containing only salicylic acid at a concentration of approximately 0.28 pptg exhibited a slight improvement in viscosity (314) over a range of time with respect to the un-stabilized baseline (310). A formulation with only ascorbic acid at a concentration of approximately 3.75 pptg exhibited a measurable improvement in viscosity over time (316) with respect to the un-stabilized baseline (310). However, a formulation containing a combination of approximately 0.28 pptg salicylic acid with approximately 3.75 pptg ascorbic acid provided a remarkable increase in stability (318) over time with respect to the un-stabilized baseline (310) and with respect to the traditional sodium thiosulfate (312). Again, this synergistic effect is most evident with the passage of time. This notable performance is achieved although a far lesser amount (approximately 4.03 pptg) of the combined solutions is used compared to the amount of sodium thiosulfate alone (approximately 12.0 pptg).

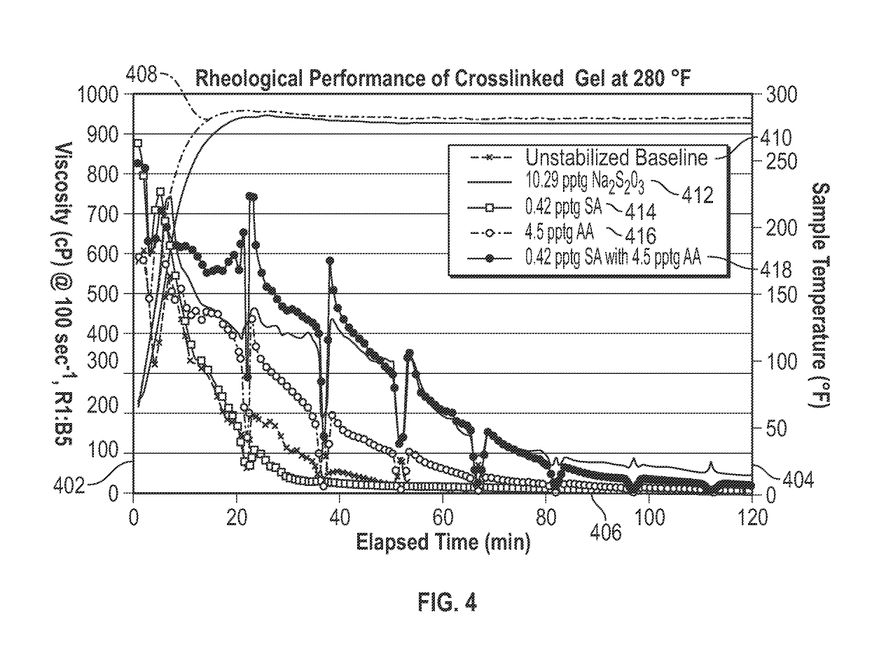

FIG. 4 is a graph comparing the rheological performance of a 30 pptg borate-crosslinked gel at 280° F. with various combinations of the component solutions disclosed in the embodiments described herein. This graph compares viscosity (402) of this high molecular weight polysaccharide solution (30 pptg borate-crosslinked guar gel) for the given increased sample temperature (404) over time (406). The corresponding temperature of each fluid sample is provided (408), thereby demonstrating the temperature consistency across each sample. A baseline of the gel without stabilizer (410) is provided. In this test, the gel using traditional sodium thiosulfate at a concentration of 10.29 pptg (412) demonstrated an expected improvement in viscosity of the gel over the entire time period. Use of a formulation containing only salicylic acid at a concentration of approximately 0.42 pptg exhibited a slight improvement in viscosity (414) over a range of time with respect to the un-stabilized baseline (410). A formulation with only ascorbic acid at a concentration of approximately 4.5 pptg exhibited a measurable improvement in viscosity (416) over time with respect to the un-stabilized baseline (410). However, a formulation containing a combination of approximately 0.42 pptg salicylic acid with approximately 4.5 pptg ascorbic acid provided a remarkable increase in stability (418) over time with respect to the un-stabilized baseline (410) and comparable performance with respect to the traditional sodium thiosulfate (412). This notable performance is achieved although a far lesser amount (approximately 4.92 pptg) of the combined solutions is used compared to the amount of sodium thiosulfate alone (approximately 10.29 pptg).

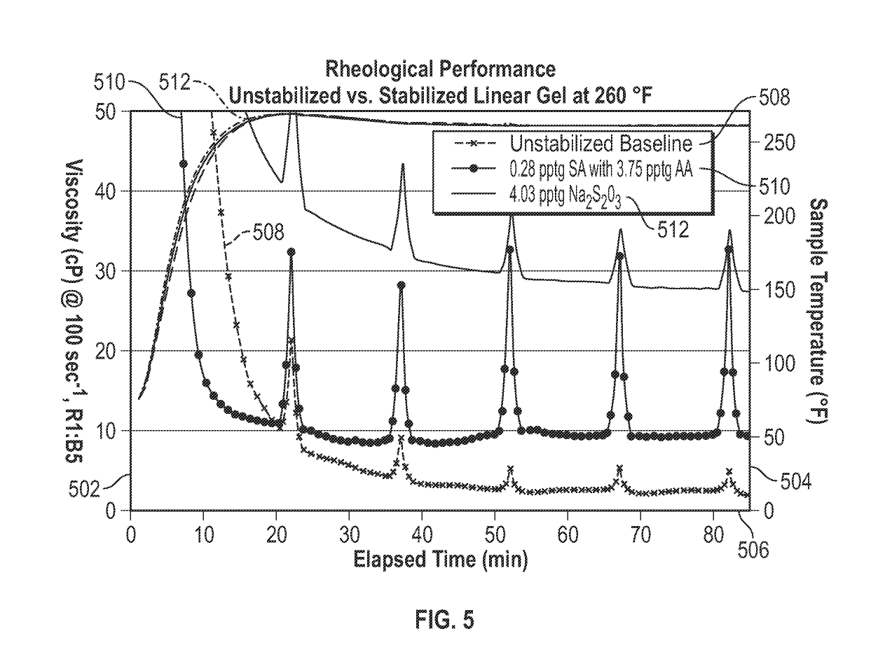

FIG. 5 is a graph comparing the rheological performance of a linear gel at 260° F. with and without the combination of the component solutions disclosed in the embodiments described herein. This graph compares viscosity (502) of this high molecular weight polysaccharide solution (linear gel) for the given increased sample temperature (504) over time (506). The corresponding temperature of each fluid sample is provided (512), thereby demonstrating the temperature consistency across each sample. A baseline of the gel without stabilizer (508) is provided, and is compared to a formulation of gel containing approximately 0.28 pptg salicylic acid and approximately 3.75 pptg ascorbic acid (510). The stabilizing effect over time is clearly visible, although not as effective as that of the traditional sodium thiosulfate (512).

This invention is also useful for the stabilization of derivatized high molecular weight polysaccharides, including derivatized guar gum (examples include CMG, HPG, CMHPG and the like) as well as derivatized cellulosics (examples include CMC, HEC, and CMHEC), which are useful in drilling, well completions, and well stimulation. Further, this invention is also useful for the stabilization of bio-fermented high molecular weight polysaccharides (examples include xanthan gum, welan gum and diutan gum), which are useful in drilling, cementing, and well completion applications.

This invention is useful in other common oilfield applications in addition to hydraulic fracturing. For example, salicylic acid and L-ascorbic acid can be used individually or synergistically to stabilize water-based, polymer drilling fluids. Drilling fluids are pumped into the wellbore during the drilling process to suspend and transport cuttings, to control pressure, and to cool and to lubricate the drill bit and surrounding area, among other commonly understood functions. When used as a suspending agent, the viscosity of the drilling fluid becomes increasingly important, particularly as the temperature increases in the wellbore during the drilling activity. Salicylic acid and ascorbic acid, used individually or synergistically as previously described, are effective in stabilizing the high molecular weight polysaccharide polymers used in such drilling fluids at these high temperatures. Similarly, salicylic acid and ascorbic acid, used individually or synergistically, are effective in stabilizing cement spacer fluids comprised of high molecular weight polysaccharides where it is desired to stabilize the viscosity of the fluid at high temperatures. Additionally, salicylic acid and ascorbic acid, used individually or synergistically, are effective in stabilizing fluids used in coil tubing applications comprised of high molecular weight polysaccharides, where it is desired to stabilize the viscosity of the fluid at high temperatures.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes coming within the meaning and range of equivalency of the claims are embraced therein. Further, the recitation of method steps does not denote a particular sequence for execution of the steps. Such method steps may therefore be performed in a sequence other than that recited unless the particular claim expressly states otherwise.

We claim:

1. A method for stabilizing the viscosity of aqueous fluids containing high molecular weight polysaccharide solutions used in subterranean formations at high temperatures and pressures, the method steps comprising:
admixing a salicylic acid solution into a high molecular weight polysaccharide solution to form a fluid mixture for introduction into a wellbore.

2. The method of claim 1, the method steps further comprising:
admixing an ascorbic acid solution into the fluid mixture.

3. The method of claim 1, the method steps further comprising:
injecting the fluid mixture into a subterranean formation at a sufficiently high pressure to create fractures.

4. The method of claim 1, the method steps further comprising:
formulating the salicylic acid solution by dissolving salicylic acid in an alcohol solvent.

5. The method of claim 4, wherein the salicylic acid solution formulation comprises the maximum percentage by weight of salicylic acid that will remain in solution.

6. The method of claim 4, wherein the salicylic acid solution formulation comprises up to approximately 34.8% by weight of salicylic acid.

7. The method of claim 1, the method steps further comprising:
formulating the salicylic acid solution by dissolving salicylic acid in an alcohol solvent, and introducing the dissolved salicylic acid and alcohol solvent solution into water.

8. The method of claim 7, wherein the salicylic acid solution formulation comprises the maximum percentage by weight of salicylic acid that will remain in solution.

9. The method of claim 7, wherein the salicylic acid solution formulation comprises up to approximately 30.2% by weight salicylic acid.

10. The method of claim 2, wherein the ascorbic acid solution formulation comprises the maximum percentage by weight of ascorbic acid that will remain in solution.

11. The method of claim 2, wherein the ascorbic acid solution formulation comprises up to approximately 25% ascorbic acid.

12. The method of claim 1, the method steps further comprising:
admixing at least one additive from the group consisting of biocides, scale inhibitors, clay controllers, surfactants, friction reducers, breakers, and crosslinkers into the fluid mixture.

13. A composition for stabilizing the viscosity of aqueous fluids containing high molecular weight polysaccharide solutions used in subterranean formations at high temperatures and pressures, the composition comprising:
a high molecular weight polysaccharide solution; and
a salicylic acid solution admixed with the high molecular weight polysaccharide solution to form a fluid mixture for introduction into a wellbore.

14. The composition of claim 13, the composition further comprising:
an ascorbic acid solution admixed with the high molecular weight polysaccharide and salicylic acid solutions.

15. The composition of claim 13, wherein the salicylic acid solution is prepared by dissolving salicylic acid in an alcohol solvent.

16. The composition of claim 15, wherein the salicylic acid solution preparation comprises the maximum percentage by weight of salicylic acid that will remain in solution.

17. The composition of claim 15, wherein the salicylic acid solution preparation comprises up to approximately 34.8% by weight of salicylic acid.

18. The composition of claim 13, wherein the salicylic acid solution is prepared by dissolving salicylic acid in an alcohol solvent, and introducing the dissolved salicylic acid and alcohol solvent solution into water.

19. The composition of claim 18, wherein the salicylic acid solution preparation comprises the maximum percentage by weight of salicylic acid that will remain in solution.

20. The composition of claim 18, wherein the salicylic acid solution preparation comprises up to approximately 30.2% by weight salicylic acid.

21. The composition of claim 14, wherein the ascorbic acid solution preparation comprises the maximum percentage by weight of ascorbic acid that will remain in solution.

22. The composition of claim 14, wherein the ascorbic acid solution preparation comprises up to approximately 25% by weight of ascorbic acid.
